(19) United States
(12) Patent Application Publication
(10) Pub. No.: US 2007/0078851 A1
(43) Pub. Date: Apr. 5, 2007

(54) System and method for filtering search query results

(76) Inventors: Mathew L. Grell, Norcross, GA (US); Scott L. Quarterman, Norcross, GA (US)

Correspondence Address: Mathew L. Grell, 4307 Jones Bridge Circle, Norcross, GA, 30092, US

(21) Appl. No.: 11/243,837

(22) Filed: Oct. 5, 2005

(51) Int. Cl. G06F 17/30

(52) U.S. Cl. 707/7

(57) ABSTRACT

A system and method for sorting or filtering search query results, wherein such invention provides for a process to access a database of service provider(s) information, a process for searching such service provider information, and a process for selectively sorting or filtering such service provider information based on area, individuals or groups of individuals the user trusts, thus, communicating such information to the user or member through conventional telecommunications and/or network infrastructure.

### TECHNICAL FIELD

The present version of the invention relates generally to Internet and/or telecommunications systems and more specifically to a method, system and apparatus for filtering search query results.

### BACKGROUND

Local service providers primarily focus the majority their advertising dollars on yellow page listings as their primary form of advertising, both in print and online, to distribute contact, goods and/or services information to customers seeking said goods and/or services. Examples of these are the regional Bell operating companies' yellow pages and websites, such as www.realpages.com www.yellowpages.com www.superpages.com and http://yp.yahoo.com. In use, a user of the yellow pages searches for a service provider by searching through an index of service providers within the yellow page book or online at one of the above listed websites. The user selects a provider and telephones the service provider by dialing the phone number listed in such directory or emails the service provider or visits service provider's website and inquires about the service provider's goods and/or services. These sites do not focus on helping the consumer make an informed decision when selecting a service provider, but rather their focus is distributing the service provider's contact information and description of their goods and/or services.

Currently, consumers have limited means available for quickly finding reputable and qualified service providers in their local area such as dry-cleaning, car repair, dentists, home improvement companies, auto mechanics, etc. Most consumers rely on the above yellow pages and or word-of-mouth referrals from their friends, family, or coworkers to find local service providers. The problem with this is that the referral is based on a very limited sample of service providers and/or the referral is likely based on a single evaluation of this service provider's performance.

Websites exist where consumers can rate and review local service providers, and where consumers have access to the contact information of such service providers. This information assists consumers when making a decision to engage the services or purchase the goods of such a provider. In addition, websites exists that allow a member to invite friends and monitor the reviews of friends, but these websites fail to allow a user to sort search queries of service providers based on reviews by friends, friends of friends, and/or groups, such as individuals or groups of individuals the user trusts, shares similar interests, needs, associations and/or other factors.

Therefore, for the foregoing reasons, it is readily apparent that there is a need for a method, system and apparatus for filtering search query results based on friends, friends of friends, and/or groups.

### BRIEF DESCRIPTION

Briefly described, in a preferred embodiment, the present version of the invention overcomes the above-mentioned disadvantage, and meets the recognized need for such an invention by providing a system and method for sorting or filtering search query results based on friends, friends of friends, groups, friends groups, city, area, highly rated reviewers, highly rated service providers, distance, proximity, coupon, or combinations thereof, wherein the present invention provides the user with the capability to sort or filter search results by selecting to apply a filter to such search results; thus, communicating such information to the user or member through conventional telecommunications and/or network infrastructure.

According to its major aspects and broadly stated, the present version of the invention in its preferred form is a method, system and apparatus for filtering search query results, comprising, in general, a process to access a database of service provider(s) information, a process for searching such service provider information, and a process for selectively sorting or filtering such service provider information.

More specifically, the present version of the invention is a communication system that shares information, such as contact information, ratings, reviews, recommendations and other information relating to service providers, with members or users and allows such members or users to selectively sort and/or filter such information based on information provided by members or user's friends, friends of friends, groups, area, highly rated reviewers, highly rated service providers, distance, proximity, coupon, or combinations thereof.

Accordingly, a feature and advantage of the present version of the invention is its ability to allow a member or user to sort and/or filter a list of service providers and their contact information, ratings, reviews, recommendations and/or other service provider information based on a member or user's list of friends.

Another feature and advantage of the present version of the invention is its ability to allow a member or user to sort and/or filter a list of service providers and their contact information, ratings, reviews, recommendations and/or other service provider information based on a member or user's list of friends and the friends of such friends.

Still another feature and advantage of the present version of the invention is its ability to allow a member or user to sort and/or filter a list of service providers and their contact information, ratings, reviews, recommendations and/or other service provider information based on a group(s) of members or users.

Yet another feature and advantage of the present version of the invention is its ability to allow a member or user to sort and/or filter a list of service providers and their contact information, ratings, reviews, recommendations and/or other service provider information based on a friend's group(s) of members or users.

Yet another feature and advantage of the present invention is its ability to allow a member or user to sort and/or filter a list of service providers and their contact information, ratings, reviews, recommendations and/or other service provider information based on a member or user's zip code, zip +4, proximity, or distance.

Yet another feature and advantage of the present invention is its ability to allow a member or user to sort and/or filter a list of service providers and their contact information, ratings, reviews, recommendations and/or other service provider information based on a member or user's metro area.

Yet another feature and advantage of the present invention is its ability to allow a member or user to sort and/or filter a list of service providers and their contact information, ratings, reviews, recommendations and/or other service provider information based on a member or user's city.

Yet another feature and advantage of the present invention is its ability to allow a member or user to sort and/or filter a list of service providers and their contact information, ratings, reviews, recommendations and/or other service provider information based on a member or user's state, region, providence, or country.

Yet another feature and advantage of the present invention is its ability to allow a member or user to sort and/or filter a list of service providers and their contact information, ratings, reviews, recommendations and/or other service provider information based on service providers offering a coupon.

Yet another feature and advantage of the present invention is its ability to allow a member or user to sort and/or filter a list of service providers and their contact information, ratings, reviews, recommendations and/or other service provider information based on highly rated members or users in your area.

Yet another feature and advantage of the present invention is its ability to allow a member or user to sort and/or filter a list of service providers and their contact information, ratings, reviews, recommendations and/or other service provider information based on highly rated service providers in your area.

These and other features and advantages of the present version of the invention will become more apparent to one skilled in the art from the following description and claims when read in light of the accompanying drawings.

### BRIEF DESCRIPTION OF THE DRAWINGS

The present version of the invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system.

FIG. 2 is a block diagram of a communications system implemented by the system in FIG. 1.

FIG. 3 is a flow diagram of a communication method, according to the preferred embodiment of the present version of the invention, implemented by the system in FIG. 2.

FIG. 4 is a screen shot of a user interface of the method of FIG. 3.

FIG. 5 is a screen shot of a user interface of the method of FIG. 3.

FIG. 6 is a screen shot of a user interface of the method of FIG. 3.

FIG. 7 is a screen shot of a user interface of the method of FIG. 3.

FIG. 8 is a screen shot of a user interface of the method of FIG. 3.

FIG. 9 is a screen shot of a user interface of the method of FIG. 3.

### DETAILED DESCRIPTION OF THE PREFERRED AND ALTERNATIVE EMBODIMENTS

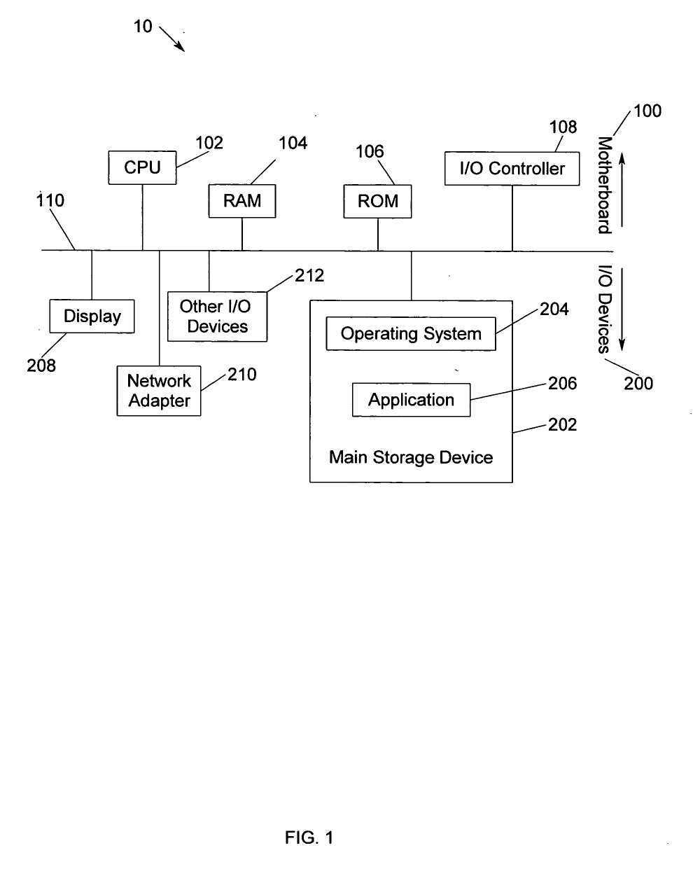

In describing the preferred and alternate embodiments of the present version of the invention, as illustrated in FIGS. 1-9, specific terminology is employed for the sake of clarity. The present version of the invention, however, is not intended to be limited to the specific terminology so selected, and it is to be understood that each specific element includes all technical equivalents that operate in a similar manner to accomplish similar functions.

As will be appreciated by one of skill in the art, the present version of the invention may be embodied as a method, data processing system, or computer program product. Accordingly, the present version of the invention may take the form of an entirely hardware embodiment, entirely software embodiment or an embodiment combining software and hardware aspects. Furthermore, the present version of the invention may take the form of a computer program product on a computer-readable storage medium having computer-readable program code means embodied in the medium. Any suitable computer readable medium may be utilized including hard disks, ROM, RAM, CD-ROMs, electrical, optical or magnetic storage devices.

The present version of the invention is described below with reference to flowchart illustrations of methods, apparatus (systems) and computer program products according to embodiments of the present version of the invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus create means for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It will also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer program for implementing the present version of the invention may be written in various programming languages, such as conventional C calling. However, it is understood that other source or object oriented programming languages, and other conventional programming languages could be utilized without departing from the spirit and intent of the present version of the invention.

Referring now to FIG. 1-9, the present version of the invention in its preferred embodiment is a system and method for sorting or filtering search query results based on friends, friends of friends, groups, friends groups, city, area, zip code, zip+4, city, metro area, state, highly rated reviewers, highly rated service providers, distance, proximity, coupon, or combinations thereof, wherein the present invention provides the user with the capability to sort or filter search results by selecting to apply a filter to such search results. For brevity, several elements in the figures described below are represented as monolithic entities. However, as would be understood by one skilled in the art, these elements each may include numerous interconnected computers and/or components designed to perform a set of specified operations and/or dedicated to a particular geographical region.

Referring now to FIG. 1, there is illustrated a block diagram of a computer system 10 that provides a suitable environment for implementing embodiments of the present version of the invention. The computer architecture shown in FIG. 1 is divided into two parts—motherboard 100 and the input/output (I/O) devices 200. Motherboard 100 includes bus 110, which interconnects major subsystems such as central processing unit (CPU) 102, random access memory (RAM) 104, input/output (I/O) controller 108, and read-only memory (ROM) 106, also known as firmware. A basic input output system (BIOS) containing the basic routines that help to transfer information between elements within the subsystems of the computer is stored in ROM 106 or operably disposed in RAM 104. The computer further includes I/O devices such as main storage device 202 for storing an operating system 204 and application program(s) 206 and display 208 for visual output, respectively. Main storage device 202 is connected to CPU 102 through a main storage controller (represented as 108) connected to bus 110. Network adapter 210 allows the computer system to send and receive data through communication devices. One example of a communications device is a modem including both cable and digital subscriber line (DSL). Other examples include a transceiver, a set-top box, a communication card, a satellite dish, an antenna, or any other network adapter capable of transmitting and receiving data over a communications link that is either a wired, optical, or wireless data pathway.

Many other devices or subsystems 212 may be connected in a similar manner, including but not limited to, devices such as microphone, speakers, sound card, keyboard, pointing device (e.g., a mouse), floppy disk, CD-ROM player, printer and/or modem each connected via I/O adapter. Also, it is not necessary for all of the devices shown in FIG. 1 to be present to practice the present version of the invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion.

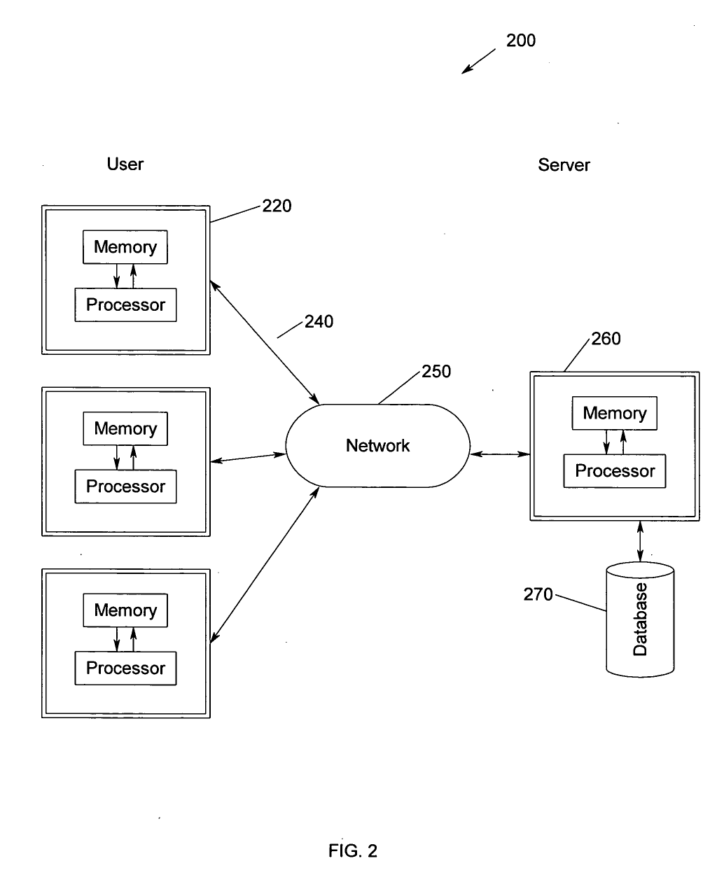

Referring now to FIG. 2, there is illustrated a diagram depicting an exemplary system in which concepts consistent with the present version of the invention may be implemented. Examples of each element within the communication system of FIG. 2 are broadly described above with respect to FIG. 1. In particular, the server system 260 and user system 220 have attributes similar to computer system 10 of FIG. 1 and illustrates one possible implementation of that system. The communication system 200 includes one or more user system 220, and one or more server device 260, and a network 250, which could be, for example, the Internet. User systems 220 each include a computer-readable medium, such as random access memory, coupled to a processor. The processor executes program instructions stored in memory. User system 220 may also include a number of additional external or internal devices, such as, without limitation, a mouse, a CD-ROM, a keyboard, a display, a storage device and other attributes similar to computer system 10 of FIG. 1. The communications system 200 typically includes one or more user system 220. For example, the user system 220 may include one or more general-purpose computers (e.g., personal computers), one or more special purpose computers (e.g., devices specifically programmed to communicate with each other and/or the server system 260), a workstation, a server, a device, a digital assistant or a “smart” cellular telephone or pager, a component, other equipment, or some combination of these elements that is capable of responding to and executing instructions.

Similar to user system 220, server system 260 includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains one or more application program(s) 206 (shown in FIG.1). For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions.

Communications system 200 is capable of delivering and exchanging data between user system 220 and a server system 260 through communication links 240 and/or network 250. Through user system 220, users can communicate over network 250 with each other and with other systems and devices coupled to network 250, such as server system 260. The communications link 240 typically includes a delivery network 250 making a direct or indirect communication between the user system 220 and the server system 260, irrespective of physical separation. Examples of a network 250 include the Internet, the World Wide Web, WANs, LANs, analog or digital wired and wireless telephone networks (e.g. PSTN, ISDN, or XDSL), radio, television, cable, satellite, and/or any other delivery mechanism for carrying and/or transmitting data or other information. The communications link 240 may include, for example, a wired, wireless, cable, optical or satellite communication system or pathway.

Application program 206 (shown in FIG. 1) includes search engine 280 (not shown), which locates relevant information in response to search queries from user system 220. In particular, a user operating user system 220 sends search queries to server system 260, which server system 260 and its application programs responds to by returning a list of relevant information to the user at user system 220. Typically, a user system 220 asks server system 260 to locate information relating to a particular category and/or sub category of service providers or based on a key word search of service providers. In a preferred embodiment of the present version of the invention search engine 280 searches a set of service provider data and/or information stored in database 270 and responds to the user's query by returning a list of relevant data and/or information to the user at user system 220 matching user's search query. The user may request server system 260 and/or user system 220 to re-order the service provider data and/or information matching user's query based on friends, friends of friends, groups, area, zip code, zip+4, city, metro area, state, highly rated reviewers, highly rated service providers, distance, proximity, coupon, or combinations thereof or other such information as would meet the purpose described herein. Application program 280 locates service providers from a body of service provider records stored in database 270 by comparing the terms in the user's search query to the service providers records in database 270. In general, processes for indexing records and searching the indexed body of records to return a set of records containing the searched terms are well known in the art.

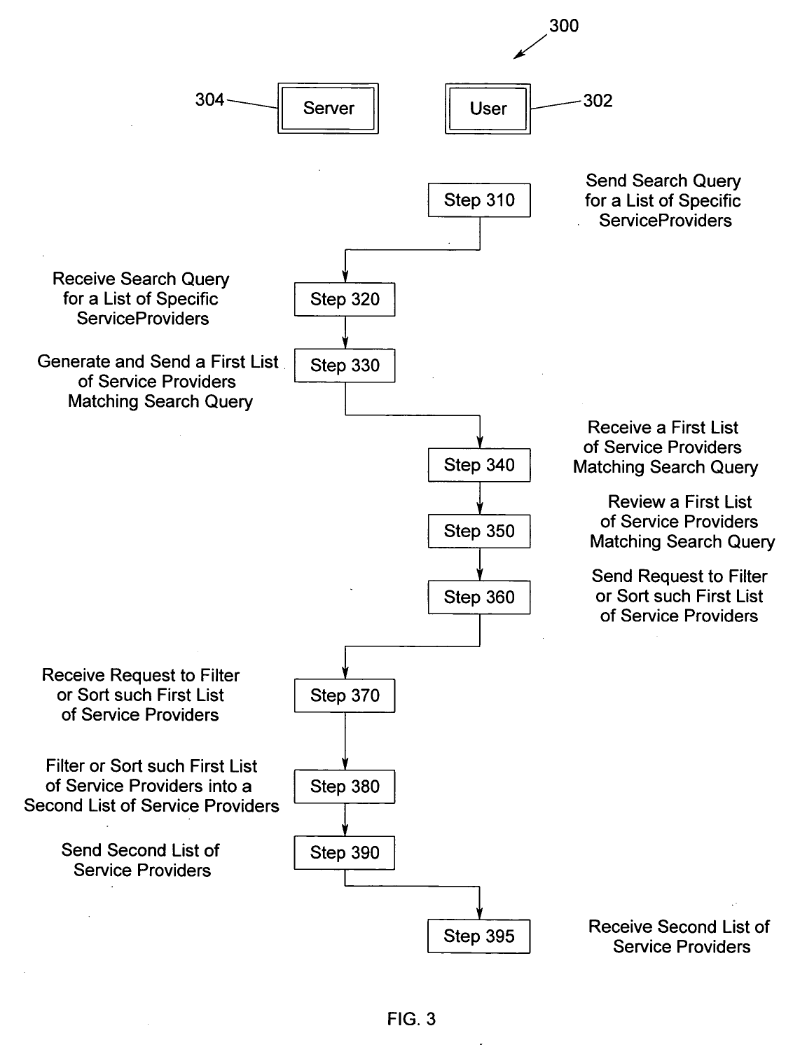

Referring now to FIG. 3, there is illustrated a preferred flow diagram in which user 302 and server 304 interact according to a process 300 within the communication system 200 of FIG. 2. User 302 preferably has attributes comparable to those described above with respect to user system 220. User is referred to hereafter as a user of communication system 200 and/or member based on the methods described herein. Server 304 preferably has attributes comparable to those described above with respect to server system 260. Server 304 is preferably interconnected to user 302 through a known or described delivery network. The network preferably has attributes comparable to those described above with respect to network 250. Procedure 300 preferably can be implemented by communication system 200 or other similar hardware, software, device, computer, computer system, equipment, component, application, code, storage medium, or propagated signal.

As illustrated in FIG. 3, user 302 preferably sends to server 304 a request or query to generate a list of specific service providers either by selecting a category and/or subcategory of service providers or by entering a key word search for such service providers (step 310). Server 304 preferably receives the request or query from user 302 to generate a list of specific service providers (step 320). In response, server 304 preferably executes such query on its database of service providers and generates a first list of specific service providers matching user's 302 search query. Next, server 304 sends user 302 such first list of specific service providers matching users 302 search query (step 330). User 302 preferably receives such first list of specific service providers matching user's 302 search query (step 340). User 302 preferably reviews such first list of specific service providers matching user's 302 search query (step 350). User 302 preferably sends to server 304 a request to filter or sort such first list of specific service providers. User's 302 request may include, but is not limited to, sorting or filtering such first list of specific service providers based on friends, friends of friends, groups, friends groups, city, area, zip code, zip+4, city, metro area, state, highly rated reviewers, highly rated service providers, distance, proximity, coupon, or combinations thereof (step 360). Server 304 preferably receives the request to filter or sort such first list of specific service providers (step 370). Server 304 preferably filters or sorts such first list of specific service providers into a second list of specific service providers based on such request of user 302. Next, server 304 sends user 302 such second list of specific service providers based on such request of user 302 (step 390). User 302 preferably receives a second list of specific service providers (step 395).

Service provider preferably is a business entity with a business line; however, including but not limited to, individual(s), sole proprietor, doing business as, partnership, limited liability company, corporation, company, limited or any other entity that is in need of advertising its goods and/or services.

Area preferably is advertiser or user's immediate area where they conduct business such as, including but not limited to, elementary, middle or high school district, area code, city, zip code, zip plus extension, GPS, radius from a central point, city, metro area, distance between two points, proximity to a point, county, state, region, providence, country, union or combination thereof.

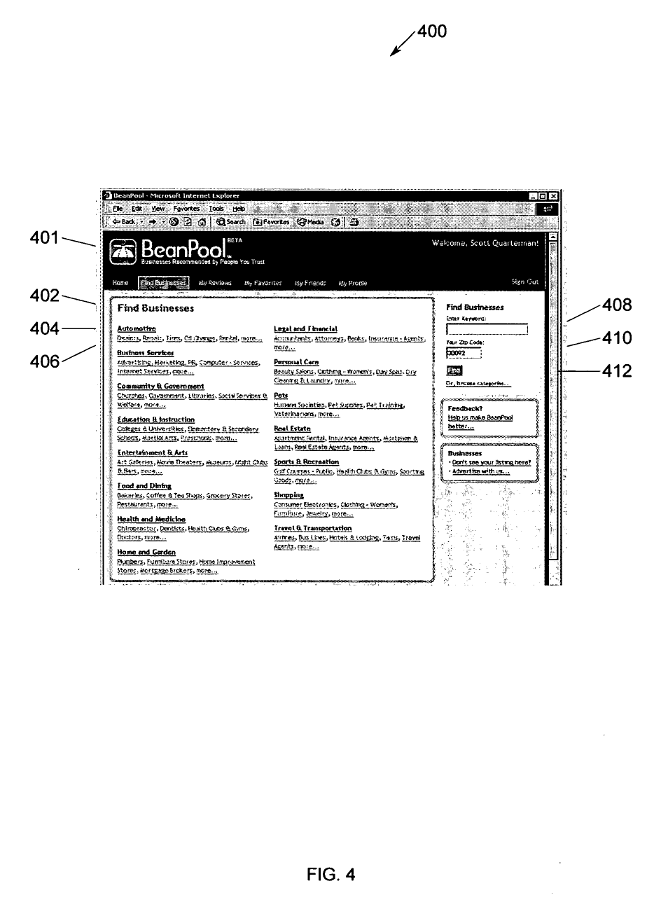

Referring now to FIG. 4, 5, 6, 7 8, and 9, user and server interact within the communication system 200 of FIG. 2. User preferably has attributes comparable to those described above with respect to user system 220. Server preferably has attributes comparable to those described above with respect to server system 260. User is preferably interconnected to server through a known or described delivery network. The network preferably has attributes comparable to those described above with respect to network 250.

Referring now to FIG. 4, there is illustrated a preferred screen shot 400 of an advertising source 401, wherein user 302 may select a service provider by clicking the tab button designated as “Find Businesses.” Upon clicking the “Find Businesses” tab, advertising source 401 generates preferred screen shot 400 listing categories 404 and subcategories 406 of service providers and alternatively provides a text entry box 408 that allows user 302 to enter a keyword search to locate service provider(s). In use, user 302 may mouse over and click any categories 404 and/or subcategories 406 or enter a test entry into text entry box 408, enter user 302 zip code into text entry box 410 and click find 412. (Step 310 of FIG. 3) Categories may include, but are not limited to, automotive, business services, community & government, education and instruction, entertainment & arts, food & dinning, health & medicine, home & garden, legal & financial, personal care, pets, real estate, sports & recreation, shopping, and/or travel & entertainment as set forth in FIG. 4.

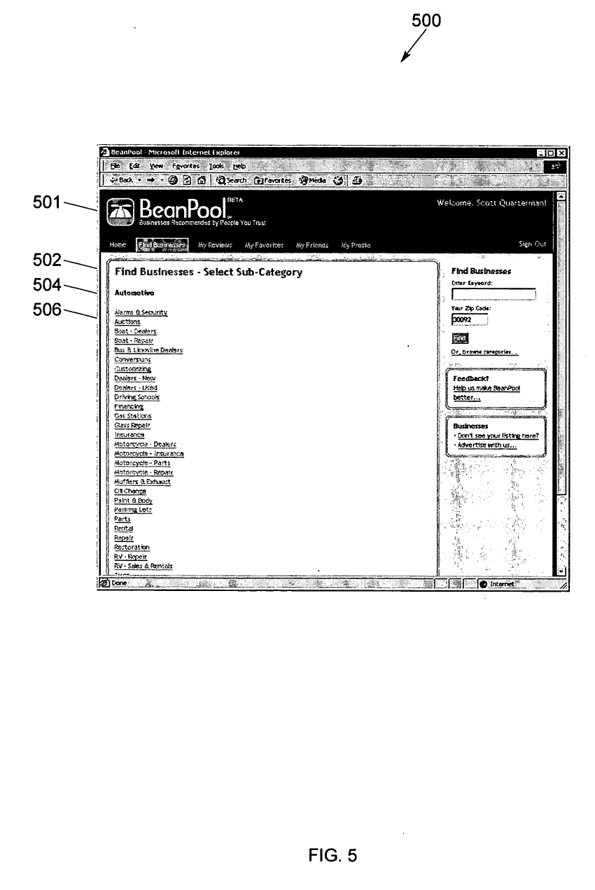

Referring now to FIG. 5, there is illustrated a preferred screen shot 500 of an advertising source 501. By way of example, and not limitation, if user 302 clicks on a category, such as “Automotive” set forth above in FIG. 4, then advertising source 501 generates preferred screen shot 500 entitled “Find Businesses—Select Sub-Category” 502 listing subcategories 506 under “Automotive” category 504. User 302 may mouse over and click any subcategories 506. (Step 310 of FIG. 3)

By way of example, and not limitation, subcategories under category “Automotive” may include Alarms & Security, Auctions, Boat-Dealers, Boat-Repair, Bus & Limosine Dealers, Conversions, Customizing, Dealers-New, Dealers-Used, Driving Schools, Financing, Gas Stations, Glass Repair, Insurance, Motorcycle-Dealers, Motorcycle-Insurance, Motorcycle-Parts, Motorcycle-Repair, Mufflers & Exhaust, Oil Change, Paint & Body, Parking Lots, Parts, Rental, Repair, Restoration, RV-Repair, RV-Sales & Rentals, Tires, Towing, Transmission Repair, Truck Dealers, and/or Washing & Detailing as set forth in FIG. 5. It is contemplated that multiple subcategories 506 exist and are represented for each category 504 and that for each category 504 or subcategory 506 advertising source 501 will generate a list of service providers matching the category 504 or subcategory 506 selected by user 302.

Service providers are classified based Standard Industrial Classification (SIC), North American Industry Classification System (NASIC) and other code classification schemes. Such codes are preferably used to classify service providers into category 504 and subcategory 506.

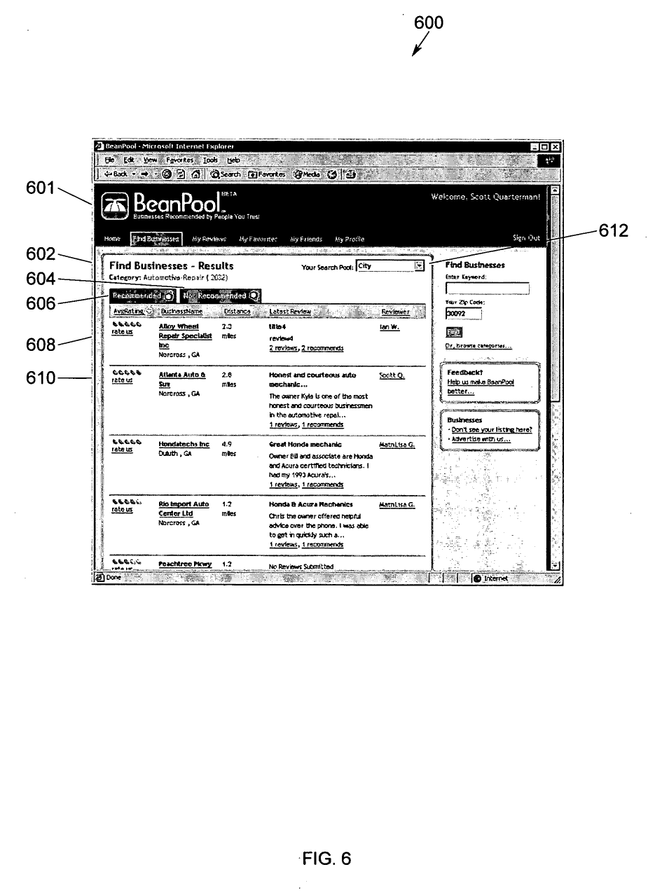

Referring now to FIG. 6, there is illustrated a preferred screen shot 600 of an advertising source 601, wherein user 302 may select a list of service provider(s) as set forth above in step 310 of FIG. 3. Upon user 302 clicking the categories 404 or subcategories 406 or clicking find 412 advertising source 601 generates preferred screen shot 600 entitled “Find Businesses—Results” 602 listing service providers matching user 302 selection such as Alloy Wheel Repair Specialists Inc 608 and Atlanta Auto & SUV 610. Preferred screen shot 600 includes tabs Recommended 606 and Not Recommended 604 each allowing user 302 to select a list of recommended service providers or not recommended service providers matching user 302 selection, respectively. Preferred screen shot 600 includes drop down window 612 entitled “Your Search Pool” populated with “City” as the selection. Preferred screen shot 600 defaults to City as “Your Search Pool” selection; however, friends, friends of friends, groups, friends groups, area, zip code, zip+4, city, metro area, state, highly rated reviewers, highly rated service providers, distance, proximity, coupon, may be selected as Your Search Pool default selection. Drop down window 612 allows user 302 to select and apply a filter to its list of service provider(s) and when set to City such list preferably includes service providers within the same city or other designated city selected by user 302. (Step 340 of FIG. 3)

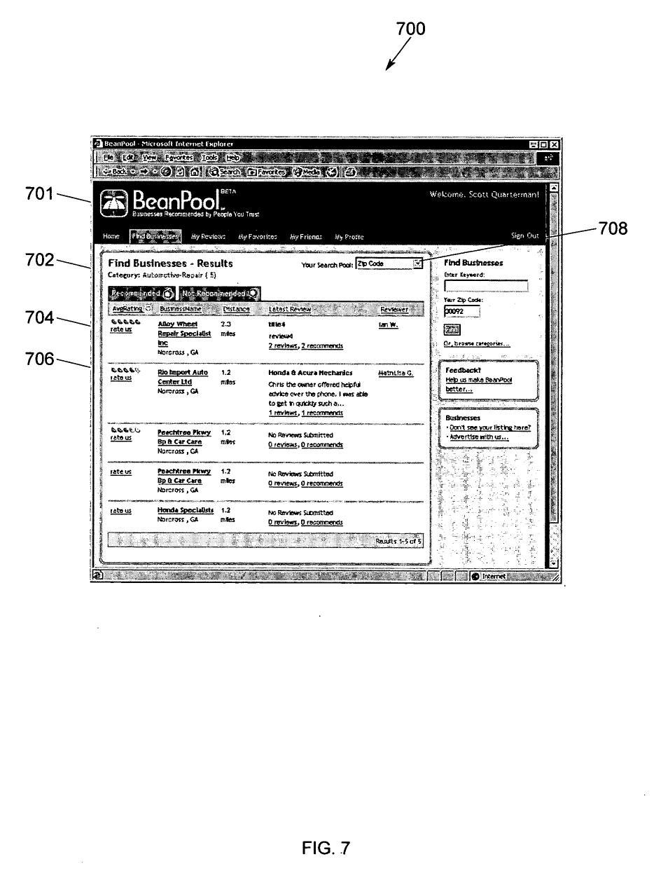

Referring now to FIG. 7, there is illustrated a alternate screen shot 700 of an advertising source 701, wherein user 302 may select a list of service provider(s) as set forth above in step 310 of FIG. 3. Upon user 302 clicking the categories 404 or subcategories 406 or clicking find 412 advertising source 701 generates alternate screen shot 700 entitled “Find Businesses—Results” 702 listing service providers matching user 302 selection such as Alloy Wheel Repair Specialists Inc 704 and Rio Imports Auto Center Ltd 706. Alternative screen shot 700 includes drop down window 708 entitled “Your Search Pool” populated with “Zip Code” as the selection. Drop down window 708 allows user 302 to select and apply a filter to its list of service provider(s) and when set to Zip Code such list preferably includes service providers within the same zip code or other designated zip code selected by user 302. (Step 395 of FIG. 3)

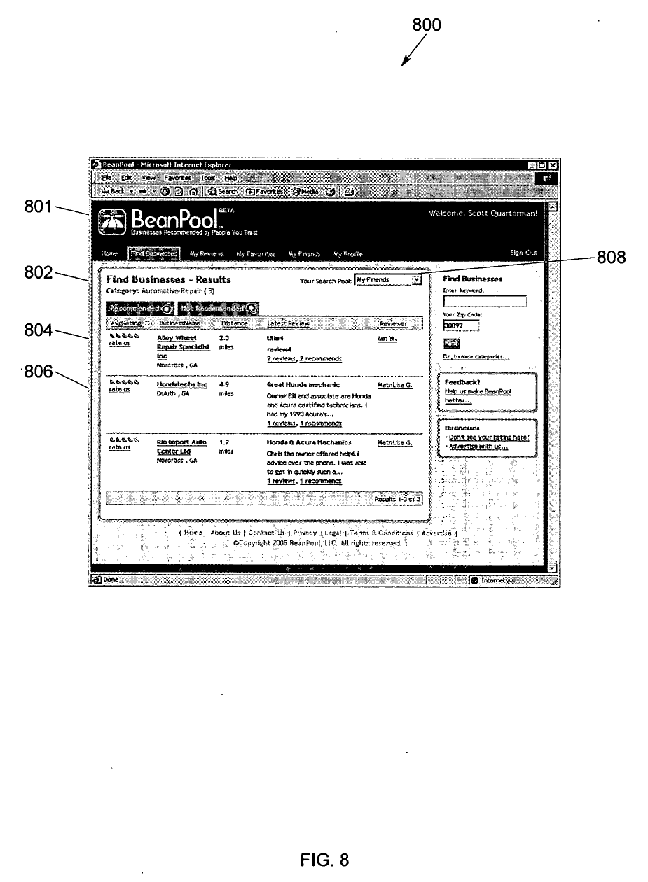

Referring now to FIG. 8, there is illustrated a alternate screen shot 800 of an advertising source 801, wherein user 302 may select a list of service provider(s) as set forth above in step 310 of FIG. 3. Upon user 302 clicking the categories 404 or subcategories 406 or clicking find 412 advertising source 801 generates alternate screen shot 800 entitled “Find Businesses—Results” 802 listing service providers matching user 302 selection such as Alloy Wheel Repair Specialists Inc 804 and Hondatechs Inc 806. Alternative screen shot 800 includes drop down window 808 entitled “Your Search Pool” populated with “Friends” as the selection. Drop down window 808 allows user 302 to select and apply a filter to its list of service provider(s) and when set to Friends such list preferably includes service providers reviewed by selected friends of user 302. Friends preferably are created when users 302 invite other users to become their friends (see the fifth tab “My Friends” on FIG. 4) within advertising source 801, because user 302 trusts or values the ratings, reviews, and/or recommendations, shares similar interests, needs, area, community, associations, home owners association, swim tennis community, parent teacher association, sports team, club, religious organization or other association and/or other factors with such users. Friends of user 302 as set forth in FIG. 8 for exemplary purposes include “Ian W.” and “MatnLisa G.”. (Step 395 of FIG. 3)

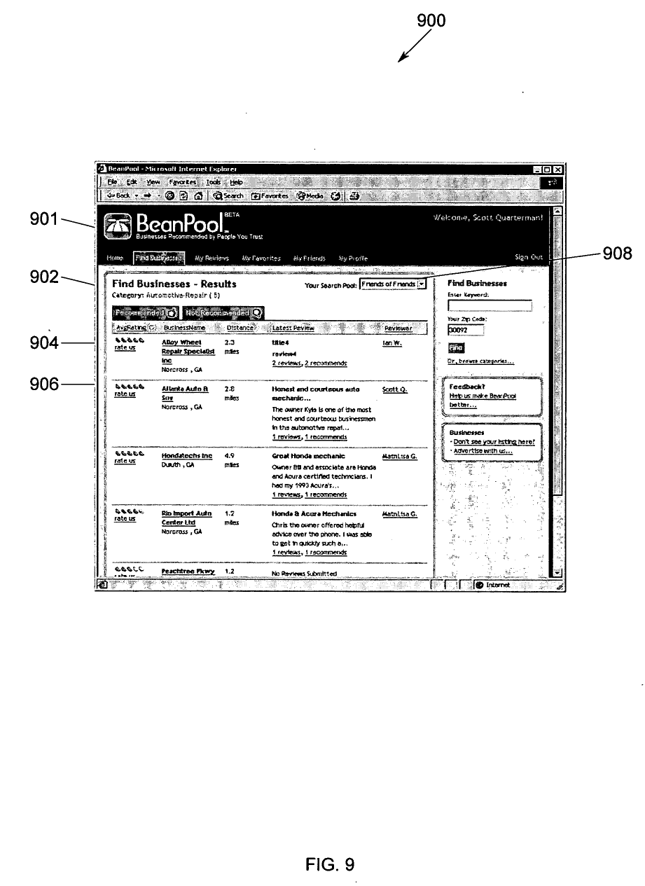

Referring now to FIG. 9, there is illustrated a alternate screen shot 900 of an advertising source 901, wherein user 302 may select a list of service provider(s) as set forth above in step 310 of FIG. 3. Upon user 302 clicking the categories 404 or subcategories 406 or clicking find 412 advertising source 901 generates alternate screen shot 900 entitled “Find Businesses—Results” 902 listing service providers matching user 302 selection such as Alloy Wheel Repair Specialists Inc 904 and Atlanta Auto & SUV 906. Alternative screen shot 900 includes drop down window 908 entitled “Your Search Pool” populated with “Friends of Friends” as the selection. Drop down window 908 allows user 302 to select and apply a filter to its list of service provider(s) and when set to Friends of Friends such list preferably includes service providers reviewed by selected friends and friends of such friends of user 302. Friends of friends are the friends of individuals invited to be friends (see the fifth tab “My Friends” on FIG. 4) of user 302 within advertising source 901. Friends of friends of user 302 as set forth in FIG. 9 for exemplary purposes, include “Ian W.”, “Scott Q.” and “MatnLisa G.”. (Step 395 of FIG. 3)

It is contemplated that other sorting or filtering categories for “Your Search Pool” may include, but are not limited to, groups, friends groups, zip code, zip+4, metro area, state, other area designations, highly rated reviewers, highly rated service providers, distance, proximity, coupon, or combinations thereof.

Groups preferably are groups of users 302 joining collectively together within advertising source based on a common interest or association, wherein such users 302 share similar interests, needs, area, community, associations, home owners association, swim tennis community, parent teacher association, sports team, club, religious organization or other association and/or other factors with such individual(s).

A highly rated reviewer preferably is a user 302 that other users within advertising source trusts or value the ratings, reviews, and/or recommendations of such user 302 and/or such highly rated reviewer is a user 302 that is invited to be a friend of many users 302 (see the fifth tab “My Friends” on FIG. 4).

A highly rated service provider preferably is a service provider with a high overall rating by one or more users 302 and/or such highly rated service provider is listed on one or more user 302 My Favorites list (see the fourth tab “My Favorites” on FIG. 4). My Favorites is a list, wherein user 302 selectively adds and maintains a list of favorite service providers.

Coupon preferably is a discount off of services and/or goods offered by service provider to user 302 within advertising source, wherein such discount may include, but not be limited to, percentage, dollar value, free good or service, give away, consultation, estimate, analysis, reference code or the like.

This non-provisional application incorporates by reference in its entirety U.S. application entitled GROUP ACCESS WITHOUT USING AN ADMINISTRATOR, Ser. No. 11/182,560 and US Application SYSTEM AND METHOD FOR IDENTIFYING THE SOURCE OF A SALES LEAD both having Applicant Mathew L. Grell.

Although the description given above includes specific examples of currently envisioned embodiments of the computer program, method, system, and/or apparatus, these possibilities should not be understood as limiting the scope of the present version of the invention but rather as providing illustrations of some of the embodiments that are now preferred. Several examples of alternate embodiments are also described and various other alternatives, adaptations, and modifications may be made within the scope of the present version of the invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present version of the invention.

What is claimed is:

1. A method of sorting a list of businesses, said method comprising the steps of:
reviewing a first list of business;
selecting a list filter; and
filtering said first list of businesses into a second list of businesses, wherein said filtering is based on said list filter.

2. The method of claim 1, wherein said list filter selected is city.

3. The method of claim 1, wherein said list filter selected is zip code.

4. The method of claim 1, wherein said list filter selected is friend.

5. The method of claim 1, wherein said list filter selected is friends of friend.

6. The method of claim 1, wherein said list filter selected is area.

7. The method of claim 1, wherein said list filter selected is group.

8. The method of claim 1, wherein said list filter selected is friend's group.

9. The method of claim 1, wherein said list filter selected is highly rated reviewer.

10. The method of claim 1, wherein said list filter selected is highly rated service provider.

11. A system for sorting a list of businesses comprising:
means for reviewing a first list of business;
means for selecting a list filter; and
means for filtering said first list of businesses into a second list of businesses, wherein said filtering is based on said list filter.

12. The system of claim 11, wherein said list filter selected is city.

13. The system of claim 11, wherein said list filter selected is zip code.

14. The system of claim 11, wherein said list filter selected is friend.

15. The system of claim 11, wherein said list filter selected is friends of friend.

16. The system of claim 11, wherein said list filter selected is area.

17. The system of claim 11, wherein said list filter selected is group.

18. The system of claim 11, wherein said list filter selected is friend's group.

19. The system of claim 11, wherein said list filter selected is highly rated reviewer.

20. The system of claim 11, wherein said list filter selected is highly rated service provider.

21. The system and method of sorting a list of businesses, said method comprising the steps of:
a server;
a user;
a communication link, wherein said user can communicate with said server using said communication link;
a step of reviewing a first list of business;
a step of selecting a list filter; and
a step of filtering said first list of businesses into a second list of businesses, wherein said filtering is based on said list filter.

22. The system and method of claim 21, wherein said list filter selected is selected from a group consisting of friends, friends of friends, groups, friends groups, area, highly rated reviewers, highly rated service providers, or coupon.
